(19) United States
(12) Patent Application Publication
(10) Pub. No.: US 2012/0264858 A1
(43) Pub. Date: Oct. 18, 2012

(54) COATING AGENT FOR THE PRODUCTION OF HIGH-IMPACT LAYERS

(75) Inventors: Horst Hintze-Brüning, Munster (DE); Hans-Peter Steiner, Sendenhorst (DE); Fabrice Leroux, Les Cendre (FR); Anne-Lise Troutier-Thuilliez, La Roche Blanche (FR); Thomas Stimpfling, Clermont-Ferrand (FR)

(73) Assignees: UNIVERSITE BLAISE PASCAL, Clermont-Ferrand (FR); BASF COATINGS GMBH, Munster (DE)

(21) Appl. No.: 13/320,409

(22) PCT Filed: Mar. 8, 2010
(86) PCT No.: PCT/EP2010/001420

§ 371 Date: Dec. 13, 2011

(30) Foreign Application Priority Data
May 13, 2009 (DE) 10 2009 021 070.9

(51) Int. Cl. C09D 167/02; C08K 5/42

(52) U.S. Cl. 524/159; 524/539

(57) ABSTRACT

The invention relates to an aqueous coating composition comprising at least one liquid-crystalline aqueous preparation (WZ) in fractions of 1% to 99% by weight, based on the aqueous basecoat material, at least one film-forming polymer (FP), and a crosslinking agent (V).

The provision of stonechip-resistant coatings on metallic substrates is especially important in the motor vehicle manufacturing sector. A surfacer or an antistonechip primer is subject to a range of requirements. Hence the surfacer coat after curing is to provide a high level of stonechip resistance, particularly toward multiple impact, and at the same time is to provide effective adhesion to the primer, more particularly to the cathodic electrocoat and to the basecoat, and is to produce good filling properties (masking of the structure of the substrate) at coat thicknesses of about 20 to 35 μm, and a good appearance for the concluding clearcoat. Moreover, suitable coating materials, for environmental reasons in particular, are preferably to have a low organic solvent content or to be very largely free from organic solvents.

Coating compositions for surfacers are known and described for example in EP-A-0 788 523 and EP-A-1 192 200. Described therein are water-dilutable polyurethanes as binders for surfacers which are intended to ensure stonechip resistance particularly at comparatively low coat thicknesses. When the prior-art surfacers are subjected to stonechip tests in OEM coat systems that are used in production-line automobile finishing (cathodic electrocoat/surfacer/basecoat/clearcoat), in spite of their good stonechip resistance, in other words a comparatively small number of defects, there are nevertheless often blemishes in the coating film where the unprotected metal substrate is exposed as a result of uncontrolled crack propagation in the OEM coat system and subsequent delamination at the boundary between metal and electrocoat.

WO-A-01/04050 discloses inorganic anionic or cationic layered fillers for aqueous coating compositions having good barrier properties, which are modified with organic compounds in order to widen the distance between the layers in the filler, said compounds having at least two ionic groups separated by at least 4 atoms. Cationic fillers used may be mixed hydroxides, such as hydrotalcite types in particular. The coating compositions described in WO-A-01/04050 are used for coatings having very good barrier properties toward gases and liquids, the intention being that the fillers should not affect the curing operation. The coating compositions described in WO-A-01/04050 are of only limited suitability for use in OEM coat systems, since the multiple charge of the organic modifiers in the applied coat generates a high local density of charges, leading macroscopically to increased hygroscopicity of the cured coat, with adverse consequences in particular for the condensation resistance of the coat. The use of the coating compositions for improving the blemishes after impact exposure in OEM coat systems, particularly for reducing the surface area of exposed substrate, is not described.

WO-A-2007/065861 describes hydroxides, more particularly hydrotalcite types, which contain at least 2 organic anions with at least 8 carbon atoms as counterions, it being possible for the anions to contain further functional groups, such as hydroxyl, amino or epoxide groups, for example. The hydrophobic hydrotalcites thus modified are described for use as intercalatable fillers for polymers, especially for rubberlike polymers. The use of hydrotalcites in coating compositions is described in general terms in WO-A-2007/065861. The hydrophobic hydrotalcites are of only limited suitability for use in aqueous coating compositions for OEM coat systems, since their compatibility with the preferably water-dispersible binders at the molecular level is poor. The use of the coating compositions for improving the blemishes after impact exposure in OEM coat systems, especially for reducing the surface area of exposed substrate, is not described in WO-A-2007/065861.

### PROBLEM AND SOLUTION

In the light of the prior art, the problem addressed by the present invention is that of providing stonechip-resistant coatings, based on environmentally advantageous aqueous coating materials, having a significantly improved blemish scenario, more particularly with a significant reduction in the delamination of the OEM coat assembly at the boundary between metal and cathodic electrocoat, and hence with a significant reduction in the surface area of exposed substrate after impact exposure. Moreover, the stonechip-resistant coatings are to exhibit a low propensity to absorb water and a low propensity toward discoloration when the coat is cured.

Aqueous coating compositions have been found, surprisingly, which solve these problems and which comprise liquid-crystalline aqueous preparations (WZ) in fractions of 1% to 99% by weight, based on the aqueous coating composition, and also comprise crosslinking agents (V), the liquid-crystalline aqueous preparations (WZ) containing preferably 10% to 99.9% by weight, based on the nonvolatile fractions of (WZ), of at least one water-dispersible polyester (PES) prepared using, in fractions of 7 to 50 mol %, based on the entirety of the polyester constituent units, difunctional monomer units (DME) having aliphatic spacer groups (SP) of 12 to 70 carbon atoms between the functional groups, and containing at least one crosslinkable reactive functional group (a), and also 0.1% to 30% by weight, based on the nonvolatile fractions of (WZ), of positively charged inorganic particles (AT) in layer form, whose individual layers that are not further intercalatable have a ratio D/d of the average layer diameter (D) to the average layer thickness (d)>50 and whose charge is at least partly compensated by singly charged organic anions (OA). As a further constituent the aqueous coating composition of the invention comprises at least one film-forming, preferably water-dispersible polymer (FP), preferably a water-dispersible polyurethane (PUR), which with particular preference comprises at least one water-dispersible polyester constituent unit (PESB) with difunctional monomer units (DME).

### DESCRIPTION OF THE INVENTION

### The Liquid-Crystalline Aqueous Preparation (WZ)

The aqueous coating composition of the invention comprises the liquid-crystalline aqueous preparation (WZ) in fractions of 1% to 99% by weight, preferably 5% to 95% by weight, based on the aqueous basecoat material.

The liquid-crystalline aqueous preparation (WZ) comprises preferably 10% to 99.9%, preferably from 15 to 95%, by weight, based on the nonvolatile fractions of the aqueous preparation (WZ), of at least one water-dispersible polyester (PES), which, in fractions of 7 to 50 mol %, based on the entirety of the polyester constituent units, contains difunctional monomer units (DME) having aliphatic spacer groups (SP) of 12 to 70 carbon atoms between the functional groups, and contains at least one crosslinkable reactive functional group (a) and also 0.1% to 30%, preferably between 1% and 20%, by weight, based on the nonvolatile fractions of (WZ), of positively charged inorganic particles (AT) in layer form, whose individual layers that are not further intercalatable have a ratio D/d of the average layer diameter (D) to the average layer thickness (d)>50 and whose charge is at least partly compensated by singly charged organic anions (OA).

### The Water-Dispersible Polyester (PES)

The preferably liquid-crystalline aqueous preparation (WZ) comprises 10% to 99.9%, preferably from 15% to 95%, by weight, based on the nonvolatile fractions (WZ), of at least one water-dispersible polyester (PES) which is prepared using, in fractions of 7 to 50 mol %, based on the entirety of the polyester constituent units, difunctional monomer units (DME) having aliphatic spacer groups (SP) of 12 to 70 carbon atoms between the functional groups (Gr), and which preferably contains at least one crosslinkable reactive functional group (a).

Water-dispersible for the purposes of the invention means that the polyesters (PES) in the aqueous phase form aggregates having an average particle diameter of <500, preferably <200, and more preferably <100 nm, or are molecularly dissolved. The size of the aggregrates composed of the polyesters (PES) can be controlled in a conventional way by introducing hydrophilic groups on the polyester (PES).

The water-dispersible polyesters (PES) incorporate the groups which are capable preferably of forming anions and which, following their neutralization, ensure that the polyesters (PES) can be stably dispersed in water. Suitable groups capable of forming anions are preferably carboxylic acid groups. To neutralize the groups capable of forming anions it is preferred likewise to use ammonia, amines and/or amino alcohols, such as, for example, diethylamine and triethylamine, dimethylaminoethanolamine, diisopropanolamine, morpholines and/or N-alkylmorpholines.

The water-dispersible polyesters (PES) preferably have mass-average molecular weights Mw (determined by means of gel permeation chromatography in accordance with standards DIN 55672-1 to -3 with polystyrene as standard) of 1000 to 100 000 daltons, more preferably of 1500 to 50 000 daltons.

The difunctional monomer units (DME) of the polyesters of the invention contain aliphatic spacer groups (SP) having 12 to 70 carbon atoms between the functional groups (Gr).

Preferred aliphatic spacer groups (SP) contain 15 to 60, very preferably 18 to 50, carbon atoms. Moreover, the spacer groups (SP) may contain cycloaliphatic or aromatic structural units having 4 to 12 carbon atoms, ethylenically unsaturated structural units in fractions of up to 30 mol %, preferably of up to 25 mol %, more preferably of up to 20 mol %, based on the entirety of the carbon atoms, and also heteroatoms, such as preferably oxygen, sulfur, and/or nitrogen.

Preferred functional groups (Gr) of the monomer units (DME) are hydroxyl and/or carboxylic acid groups and/or carboxylic anhydride groups. Monomer units having in each case 2 hydroxyl groups or 2 carboxylic acid groups are particularly preferred.

Monomer units (DME) used with preference are diols and/or dicarboxylic acids and/or their anhydrides with spacer groups (SP) of 12 to 70, preferably 15 to 60, more preferably of 18 to 50 carbon atoms.

Especially preferred monomer units (DME) are dimeric fatty alcohols and/or dimeric olefinically unsaturated fatty acids and/or their hydrogenated derivatives which meet the aforementioned criteria, such as, in particular, dimeric fatty acids of the Pripol® series from Unichema.

The monomer units (DME) are used in fractions of 7 to 50 mol %, preferably of 8 to 45 mol %, more preferably of 9 to 40 mol %, based on the entirety of the constituent units of the water-dispersible polyester (PES).

As further constituent units, the water-dispersible polyester (PES) comprises preferably the following monomer units (MEn):
in fractions of 1 to 40 mol %, preferably of 2 to 35 mol %, more preferably of 5 to 30 mol %, based on the entirety of the constituent units of the water-dispersible polyester, unbranched aliphatic and/or cycloaliphatic diols (ME1) having 2 to 12 carbon atoms, such as, in particular, ethylene glycol, diethylene glycol, 1,3-propanediol, dipropylene glycol, 1,4-butanediol, 1,6-hexanediol, 1,1,4-cyclohexanediol and/or 1,4-dimethylolcyclohexane, more preferably 1,4-butanediol and/or 1,6-hexanediol. Unbranched for the purposes of the invention means that the aliphatic and/or cycloaliphatic carbon units contain no further aliphatic substituents;
in fractions of 1 to 50 mol %, preferably of 2 to 40 mol %, more preferably of 5 to 35 mol %, based on the entirety of the constituent units of the water-dispersible polyester, branched aliphatic and/or cycloaliphatic diols (ME2) having 4 to 12 carbon atoms, such as, in particular, neopentyl glycol, 2-methyl-2-propylpropanediol, 2-ethyl-2-butylpropanediol, 2,2,4-trimethyl-1,5-pentanediol, 2,2,5-trimethyl-1,6-hexanediol, more preferably neopentyl glycol. Branched for the purposes of the invention means that the aliphatic and/or cycloaliphatic carbon units contain further aliphatic substituents;
optionally in fractions of 0 to 30 mol %, preferably of 2 to 25 mol %, more preferably of 5 to 20 mol %, based on the entirety of the constituent units of the water-dispersible polyester, aliphatic, cycloaliphatic and/or aromatic dicarboxylic acids (ME3) having 4 to 12 carbon atoms, such as, in particular oxalic acid, malonic acid, succinic acid, glutaric acid, adipic acid, sebacic acid, maleic acid, fumaric acid, isophthalic acid, terephthalic acid, orthophthalic acid, tetrahydrophthalic acid, hexahydrophthalic acid, 1,2-cyclohexanedicarboxylic acid, 1,4-cyclohexanedicarboxylic acid and/or the anhydrides thereof, more preferably 1,2-cyclohexanedicarboxylic acid; and
optionally in fractions of 0 to 40 mol %, preferably of 0 to 35 mol %, more preferably of 0 to 30 mol %, based on the entirety of the constituent units of the water-dispersible polyester, aliphatic, cycloaliphatic and/or aromatic polycarboxylic acids (ME4) having at least 3 carboxylic acid groups, such as, in particular, benzenetricarboxylic acids, such as benzene-1,2,4-tricarboxylic acid and benzene-1,3,5-tricarboxylic acid, trimellitic acid, pyromellitic acid, glyceric acid, malic acid and/or the anhydrides thereof, more preferably benzenetricarboxylic acids, such as benzene-1,2,4-tricarboxylic acid and benzene-1,3,5-tricarboxylic acid.

The reaction of the monomer units (DME), (ME1), (ME2), and also, where present, (ME3) and (ME4), takes place in accordance with the generally well-known methods of polyester chemistry. The reaction temperature is preferably at 140 to 240 degrees C., preferably at 150 to 200 degrees C. In certain cases it is appropriate to catalyze the esterification reaction, in which case examples of catalysts employed include tetraalkyl titanates, zinc alkoxylates and/or tin alkoxylates, dialkyltin oxides or organic salts of the dialkyltin oxides.

In the preferred embodiment of the invention, first of all, in a first stage, the monomer units (DME), (ME1), (ME2), and where used (ME3), are reacted with one another in a suitable solvent to give a polyester polyol, which can be used per se as aqueous polyester (PES) of the invention, the molar ratio of the sum of all the diols (ME1), (ME2), and, optionally, (DME) to the sum of all the dicarboxylic acids (ME3) and, optionally, (DME) being between 3.5:1 and 1.5:1, preferably between 3:1 and 1.75:1, and more preferably between 2.5:1 and 2:1, before, optionally, in a second stage, the polyester polyol is reacted with the monomer units (ME4) to give the water-dispersible polyester (PES) of the invention. The acid number of the water-dispersible polyesters (PES) in accordance with DIN EN ISO 3682 is preferably between 10 and 80 mg KOH/g, more preferably between 20 and 60 mg KOH/g nonvolatile fraction.

Furthermore, the water-dispersible polyesters (PES) preferably carry crosslinkable reactive functional groups (a), with suitability being possessed in principle by all groups which are able to react with themselves and/or with further functional groups of the polyester (PES) and/or with further constituents of the aqueous coating composition of the invention, in particular with the crosslinking agent (V), to form covalent bonds. Groups of this kind are introduced via the aforementioned monomer constituent units (DME) and/or (MEn) or via further constituent units which contain such groups.

By way of example of groups (a) which react with themselves, mention may be made of the following: methylol, methylol ether, N-alkoxymethylamino, and in particular alkoxysilyl groups. Hydroxyl, amino and/or epoxy groups are preferred in particular as groups (a). Particular preference is given to hydroxyl groups, the hydroxyl number of the water-dispersible polyester (PES) in accordance with DIN EN ISO 4629 being preferably between 10 and 500, more preferably between 50 and 200 mg KOH/g nonvolatile fraction.

### The Inorganic Particles (AT)

In the preferred liquid-crystalline aqueous preparation (WZ) there is 0.1% to 30%, preferably between 1% and 20%, by weight, based on the nonvolatile fractions (WZ), of solid or preferably suspended, positively charged inorganic particles (AT) that are of layer form and whose individual layers that are not further intercalatable have a ratio D/d of the average layer diameter (D) to the layer thickness (d)>50, and whose charge is at least partly compensated by singly charged organic anions (OA). The average layer diameters (D) can be determined by way of the evaluation of SEM (Scanning Electron Microscopy) graphs, while the layer thickness (d) is defined by the molecular construction and the resultant crystal structure, and can be determined arithmetically and also comprehended experimentally from X-ray structural analyses or profile measurements by means of AFM (Atomic Force Microscopy) on individual platelets. The average layer diameter (D) of the positively charged inorganic particles (AT) is preferably between 100 and 1000 nm, more preferably between 200 and 500 nm; the layer thickness (d) is preferably less than 1.0 nm, preferably less than 0.75 nm.

The positively charged inorganic particles (AT) can be produced by swapping the naturally present or as-synthesized counterions (A) of the minerals in layer form for the singly charged organic anions (OA), in accordance with conventional methods, or by carrying out synthesis in the presence of the singly charged organic anions (OA). For this purpose, for example, the positively charged organic particles (AT) are suspended in a suitable liquid medium which is capable of swelling the interstices between the individual layers, and in which the organic anions (OA) are in solution, and subsequently isolated again (Langmuir 21 (2005), 8675).

When ionic exchange takes place, preferably more than 15 mol %, more preferably more than 30 mol %, of the counterions (A) from the synthesis are replaced by the singly charged organic anions (OA). Depending on the size and the spatial orientation of the organic counterions, the layer structures are generally widened, with the distance between the electrically charged layers being widened preferably by at least 0.2 nm, more preferably by at least 0.5 nm.

Preferred in accordance with the invention are positively charged inorganic particles (AT) of layer form, such as, more particularly, the mixed hydroxides of the formula:

(M₍₁₋ₓ₎²⁺Mₓ³⁺(OH)₂)(A_{x/y}^{y-}).nH₂O

where M²⁺ represents divalent cations, M³⁺ represents trivalent cations, and anions (A) having a valence y as counterions, with x adopting a value of 0.05 to 0.5, and with some of the counterions (A) being replaced by the singly charged organic anions (OA).

Particularly preferred divalent cations M²⁺ are calcium, zinc and/or magnesium ions, particularly preferred trivalent cations M³⁺ are aluminum ions; and particularly preferred anions (A) are phosphate ions, sulfate ions and/or carbonate ions, since these ions very largely ensure that there is no change in shade when the coat of the invention is cured. The synthesis of the mixed hydroxides is known (for example, Eilji Kanezaki, Preparation of Layered Double Hydroxides, in Interface Science and Technology, Vol. 1, Chapter 12, page 345ff—Elsevier, 2004, ISBN 0-12-088439-9). The synthesis usually takes place from the mixtures of the salts of the cations in aqueous phase at defined, basic pH levels which are kept constant. The products are the mixed hydroxides, containing the anions of the metal salts as inorganic counterions (A) intercalated into the interstices. Where the synthesis takes place in the presence of carbon dioxide, the product is generally the mixed hydroxide with intercalated carbonate ions (A). If the synthesis is carried out in the absence of carbon dioxide and/or carbonate, in the presence of singly charged organic anions (OA) or their acidic precursors, the product is generally the mixed hydroxide having organic anions (OA) intercalated into the interstices (coprecipitation method or template method). An alternative synthesis route for the preparation of the mixed hydroxides is the hydrolysis of the metal alkoxides in the presence of the desired anions to be intercalated (U.S. Pat. No. 6,514,473). It is possible, moreover, to introduce the singly charged organic anions (OA) for intercalation by means of ion exchange on mixed hydroxides with intercalated carbonate ions (A). This can be done, for example, by rehydrating the amorphous calcined mixed oxide in the presence of the desired anions (OA) for intercalation. Calcining the mixed hydroxide containing intercalated carbonate ions (A) at temperatures <800° C. yields the amorphous mixed oxide, with retention of the layer structures (rehydration method).

Alternatively the ion exchange may take place in an aqueous or aqueous-alcoholic medium in the presence of the acidic precursors of the organic anions to be intercalated. In this case, depending on the acid strength of the precursors of the singly charged organic anions (OA) for intercalation, treatment with dilute mineral acids is needed in order to remove the carbonate ions (A).

The charge carriers of the singly charged organic anions (OA) that are used for at least partial compensation of the charge and for widening the aforementioned mixed hydroxides are anionic groups (AG), such as, with particular preference, singly charged anions of carboxylic acid, of sulfonic acid and/or of phosphonic acid. The singly charged organic anions (OA) preferably have molecular weights of <1000 daltons, more preferably <500 daltons.

In one preferred embodiment of the invention the singly charged organic anions (OA) additionally carry functional groups (c) which, when the coating composition is cured, react, where appropriate, with functional groups (a) of the polymer (FP) to form covalent bonds. Particular preference is given to the functional groups (c) selected from the group of hydroxyl, epoxy and/or amino groups.

The functional groups (c) are separated from the anionic groups (AG) of the singly charged organic anions (OA) preferably by a spacer, the spacer being selected from the group of the optionally substituted aliphatics and/or cycloaliphatics which are optionally modified with heteroatoms, such as nitrogen, oxygen and/or sulfur, and have a total of 2 to 30 carbon atoms, preferably between 3 and 20 carbon atoms, of the optionally substituted aromatics which are optionally modified with heteroatoms, such as nitrogen, oxygen and/or sulfur, and have a total of 2 to 20 carbon atoms, preferably between 3 and 18 carbon atoms, and/or of the substructures of the above-recited cycloaliphatics and aromatics, the substructures containing in particular at least 3 carbon atoms and/or heteroatoms between the functional group (c) and the anionic group (AG).

With particular preference the spacers of the singly charged organic anions (OA) are optionally substituted phenyl or cyclohexyl radicals which contain the functional group (c) in m- or p-position in relation to the anionic group (AG). Use is made in particular here of hydroxyl and/or amino groups as functional group (c) and of carboxylate and/or sulfonate groups as anionic group (AG). In a further embodiment of the invention the organic anions (OA) contain at least two of the above-recited functional groups (c).

Especially preferred as singly charged organic anions (OA) with a functional group (c) are the following:
m- or p-aminobenzenesulfonate, m- or p-hydroxybenzenesulfonate, m- or p-aminobenzoate and/or m- or p-hydroxybenzoate;
   and especially preferred as singly charged organic anions (OA) having two functional groups (c) are the following:
3-hydroxy-4-aminobenzenesulfonate, 3-amino-4-hydroxybenzenesulfonate, 3-hydroxy-4-aminobenzoate and/or 3-amino-4-hydroxybenzoate.

In the case of the abovementioned particularly preferred mixed hydroxides which by virtue of their synthesis contain preferably carbonate as anion (A), the ion exchange replaces preferably more than 15 mol %, more preferably more than 30 mol %, of the anions (A) by the singly charged organic anions (OA).

The modification of the cationically charged inorganic particles (AT) is preferably carried out in a separate process prior to incorporation into the coating composition of the invention, this process being carried out with particular preference in an aqueous medium. The electrically charged inorganic particles (AT) modified with the singly charged organic anions (OA) are preferably prepared in one synthesis step. The particles prepared in this way have only a very slight inherent color, and preferably are colorless.

The positively charged particles (AT) modified with singly charged organic anions (OA) can be prepared in one synthesis step in particular from the metal salts of the cations and from the organic anions. In that case, preferably, an aqueous mixture of salts of the divalent cations M²⁺ and of the trivalent cations M³⁺ is introduced into an aqueous alkaline solution of the singly charged organic anion (OA) until the desired stoichiometry is established. The addition takes place preferably in a CO₂-free atmosphere, preferably under an inert gas atmosphere, as for example under nitrogen, with stirring at temperatures between 10 and 100 degrees C., preferably at room temperature, with the pH of the aqueous reaction mixture being maintained in the range from 8 to 12, preferably between 9 and 11, preferably by addition of alkaline hydroxides, more preferably NaOH. Following addition of the aqueous mixture of the metal salts, the resulting suspension is aged at the aforementioned temperatures for a period of 0.1 to 10 days, preferably 3 to 24 hours, and the resulting precipitate is isolated, preferably by centrifuging, and washed repeatedly with deionized water. Thereafter, from the purified precipitate, a suspension is established, using water, of the positively charged particles (AT) modified with the singly charged organic anions (OA) with a solids content of 5% to 50%, preferably of 10 to 40%, by weight.

The thus-prepared suspensions of the modified, positively charged inorganic particles (AT) can be incorporated in principle during any phase of the process of the invention for producing the coating composition—that is, before, during and/or after the addition of the other components of the coating composition.

The crystallinity of the resulting doubled mixed hydroxides in layer form as modified positively charged inorganic particles (AT), which are generally obtained not as individual layers but rather as layer stacks and are used in that form, is dependent on the selected synthesis parameters, on the nature of the cations employed, on the ratio of the M²⁺/M³⁺ cations, and on the nature and the amount of the anions employed, and ought to adopt values which are as large as possible.

The crystallinity of the mixed hydroxide phase can be expressed as the calculated size of the coherent scattering domains from the analysis of the corresponding X-ray diffraction lines, examples being the [003] and [110] reflections in the case of the Mg—Al-based mixed doubled hydroxide. Thus, for example, Eliseev et al. show the effect of thermal aging on the growth of the domain size of the Mg—Al-based mixed doubled hydroxide investigated, and explain this by the progressive incorporation of extant tetrahedrally coordinated aluminum into the mixed hydroxide layer in the form of octahedrally coordinated aluminum, shown via the relative intensities of the corresponding signals in the ²⁷Al NMR spectrum (Doklady Chemistry 387 (2002), 777).

### Further Constituents of the Aqueous Liquid-Crystalline Preparations (WZ)

The liquid-crystalline aqueous preparation (WZ) may further comprise customary coatings additives in effective amounts. Thus, in the liquid-crystalline aqueous preparations (WZ), in addition to the preferred inorganic particles (AT), the preferred polyesters (PES), and the film-forming polymers (FP), more particularly the water-dispersible polyurethanes (PUR), there may in particular be water-miscible or water-soluble solvents present in fractions of up to 40%, preferably of up to 30%, more preferably of up to 20%, by weight, based on the nonvolatile fractions of (WZ). Further examples of suitable coatings additives are described in, for example, the textbook “Lackadditive” [Additives for Coatings] by Johan Bieleman, Verlag Wiley-VCH, Weinheim, N.Y., 1998.

### The Preparation of the Liquid-Crystalline Aqueous Preparations (WZ)

The liquid-crystalline aqueous preparations (WZ) are preferably prepared by first mixing all of the constituents of the preparation apart from the modified, positively charged inorganic particles (AT) in layer form and, where appropriate, the crosslinking agent (V). The inorganic particles (AT) or, preferably, the suspension of the inorganic particles (AT) prepared preferably by the above-recited process are introduced with stirring into the resulting mixture, preferably until the suspension is uniformly dispersed, something which can be monitored by optical methods, more particularly by visual inspection.

The resulting mixture is treated preferably at temperatures between 10 and 50 degrees C., preferably at room temperature, for a period of 2 to 30 minutes, preferably of 5 to 20 minutes, with stirring and ultrasound for obtaining a more finely divided, more homogeneous dispersion of the preparation of the inorganic particles AT; in one particularly preferred embodiment, the tip of an ultrasound source is immersed into the mixture. During the ultrasound treatment the temperature of the mixture may rise by 10 to 60 K. The dispersion thus obtained is aged preferably for at least 12 hours with stirring at room temperature. Thereafter, where appropriate, the crosslinking agent (V) is added, with stirring, and the dispersion is adjusted preferably with water to a solids content of 10 to 70%, preferably 15 to 60%, by weight.

### The Properties of the Liquid-Crystalline Aqueous Preparations (WZ)

The preparations (WZ) have liquid-crystalline properties. In particular, under crossed polarizers, they display a birefringent phase, which depending on the concentration of the component (AT) of the invention may be present alongside an isotropic phase. The texture of the birefringent phase is a close match to the textures of the kind ascribed to nematic phases.

By means of ultra-small-angle X-ray scattering on the aqueous preparations of the invention, and also by means of scanning electron microscopy imaging of cryogenic fracture samples (cryo-SEM), it is possible to image the typical lamellar layer structures, and to characterize them in terms of their average interplanar spacings from the 1st-order intensity maxima.

### The Film-Forming Water-Dispersible Polymer (FP)

Besides the liquid-crystalline aqueous preparation (WZ), as a further constituent, the aqueous effect basecoat material of the invention comprises preferably 5% to 80%, more preferably 10% to 60%, by weight, based on the nonvolatile fractions of the aqueous effect basecoat material, of a water-dispersible, film-forming polymer (FP). Water-dispersible, film-forming polymers of this kind are described for example in WO-A-02/053658, in EP-A-0 788 523, and in EP-A-1 192 200; in the present invention it is preferred to employ film-forming polymers (FP) from the group of the water-dispersible polyesters, which differ from the above-described polyesters (PES), of the water-dispersible polyacrylates, of the water-dispersible polyurethanes and/or of the water-dispersible acrylated polyurethanes. With particular preference the form-forming polymers (FP) carry crosslinkable functional groups (a), as already described in the context of the water-dispersible polyesters (PES), with particular preference being given to hydroxyl groups.

In one preferred embodiment of the invention the water-dispersible film-forming polymer (FP) comprises at least one water-dispersible polyurethane (PUR) which with particular preference comprises at least one polyester constituent unit (PESB) with the above-described difunctional monomer units (DME) in fractions of 1 to 40 mol %, preferably of 2 to 35 mol %, more preferably of 5 to 30 mol %, based on the entirety of the constituent units of the polyester constituent unit (PESB).

Water-dispersible for the purposes of the invention means that the polyurethane (PUR) in the aqueous phase forms aggregates having an average particle diameter of <500, preferably <200 and more preferably <100 nm or is in molecularly disperse solution. The size of the aggregates composed of the polyurethane (PUR) can be controlled in conventional manner by introduction of hydrophilic groups on the polyurethane (PUR).

The water-dispersible polyurethane (PUR) incorporates the groups which are capable preferably of forming anions and which, after their neutralization, ensure that the polyurethane (PUR) can be stably dispersed in water. Suitable groups capable of forming anions are preferably carboxylic acid groups. To neutralize the groups capable of forming anions it is likewise preferred to use ammonia, amines, and/or amino alcohols, such as diethylamine and triethylamine, dimethylaminoethanolamine, diisopropanolamine, morpholines and/or N-alkylmorpholines, for example.

The difunctional monomer units (DME) of the polyester constituent unit (PESB) of the polyurethane (PUR) contain aliphatic spacer groups (SP) having 12 to 70 carbon atoms between the functional groups (Gr). Preferred spacer groups (SP) and monomer units (DME) of the polyester constituent unit (PESB) are set out in the description of the water-dispersible polyester (PES).

Very particularly preferred monomer units (DME) of the polyester constituent unit (PESB) are dimeric fatty alcohols and/or dimeric olefinically unsaturated fatty acids and/or their hydrogenated derivatives, which satisfy the aforementioned criteria, such as, in particular, dimeric fatty acids of the Pripol® series from Unichema.

As further constituent units, the preferred polyester constituent unit (PESB) of the polyurethane (PUR), where appropriate in addition to further monomer units, comprises preferably the following monomer units (MEnn):

In fractions of 1 to 80 mol %, preferably of 2 to 75 mol %, more preferably of 5 to 70 mol %, based on the entirety of the constituent units of the polyester constituent unit (PESB), unbranched aliphatic and/or cycloaliphatic diols (ME11) having 2 to 12 carbon atoms, such as, in particular, ethylene glycol, diethylene glycol, 1,3-propanediol, dipropylene glycol, 1,4-butanediol, 1,6-hexanediol, 1,1,4-cyclohexanediol and/or 1,4-dimethylolcyclohexane, more preferably 1,4-butanediol and/or 1,6-hexanediol. Unbranched for the purposes of the invention means that the aliphatic and/or cycloaliphatic carbon units contain no further aliphatic substituents.

In fractions of 1 to 40 mol %, preferably of 2 to 35 mol %, more preferably of 5 to 30 mol %, based on the entirety of the constituent units of the polyester constituent unit (PESB), aliphatic, cycloaliphatic and/or aromatic dicarboxylic acids (ME22) having 4 to 12 carbon atoms, such as in particular, oxalic acid, malonic acid, succinic acid, glutaric acid, adipic acid, sebacic acid, maleic acid, fumaric acid, isophthalic acid, terephthalic acid, orthophthalic acid, tetrahydrophthalic acid, hexahydrophthalic acid, 1,2-cyclohexanedicarboxylic acid, 1,4-cyclohexanedicarboxylic acid, and/or the anhydrides thereof, more preferably isophthalic acid.

The reaction of the monomer units (DME), (ME11), (ME22) and, where appropriate, further monomer units takes place in accordance with the generally well-known methods of polyester chemistry. The reaction temperature is preferably at 140 to 240 degrees C., preferably at 150 to 200 degrees C. In certain cases it is appropriate to catalyze the esterification reaction, examples of catalysts employed being tetraalkyl titanates, zinc alkoxylates and tin alkoxylates, dialkyltin oxides or organic salts of the dialkyltin oxides.

The water-dispersible polyurethanes (PUR) are synthesized preferably from the polyester constituent units (PESB) and also, where appropriate, further polyols of low molecular mass and/or higher molecular mass, having at least 2 hydroxyl groups per polyol unit, which are reacted preferably with bisisocyanato compounds and/or mixtures thereof and/or their dimeric, trimeric or tetrameric adducts, such as, in particular, biurets or isocyanurates, such as, preferably, hexamethylene diisocyanate, isophorone diisocyanate, TMXDI, 4,4′-methylenebis(cyclohexyl isocyanate), 4,4′-methylenebis(phenyl isocyanate), 1,3-bis(1-isocyanato-1-methylethyl)benzene, more preferably hexamethylene diisocyanate and/or isophorone diisocyanate, and compounds capable of forming anions, such as, in particular, 2,2-bis(hydroxymethyl)propionic acid, to form the polyurethane. The polyurethanes (PUR) are preferably of branched construction as a result of the proportional use of polyols, preferably triols, more preferably 1,1,1-tris(hydroxymethyl)propane.

The water-dispersibility of the polyurethanes is achieved through neutralization of the groups capable of forming anions, preferably with amines, more preferably with diethanolamine, with preference being given to a degree of neutralization of between 80 and 100%, based on the entirety of the neutralizable groups.

In one preferred embodiment of the invention the water-dispersible polyurethanes (PUR) carry crosslinkable functional groups (a) as already described for the water-dispersible polyesters (PES). Particular preference is given to hydroxyl groups, the hydroxyl number of the film-forming polymers (FP) in accordance with DIN EN ISO 4629 being preferably between 0 and 200, more preferably between 0 and 100 mg KOH/g nonvolatile fraction, and in particular the hydroxyl number of the water-dispersible polyurethane (PUR) in accordance with DIN EN ISO 4629 being preferably between 0 and 50, more preferably between 0 and 30 mg KOH/g nonvolatile fraction.

### The Crosslinking Agent (V)

The crosslinking agent (V) used with preference in the invention preferably contains at least two functional groups (b) which, as complementary groups, react with the functional groups (a) of the water-dispersible polyester (PES) and/or of the film-forming polymer (FP), in particular of the polyurethane (PUR), when the coating composition is cured, to form covalent bonds. The functional groups (b) may be brought to reaction by radiation and/or thermally. Thermally crosslinkable groups (b) are preferred.

The crosslinking agent (V) is present in the aqueous coating composition of the invention preferably in fractions of 2% to 50% by weight, more preferably of 5% to 40% by weight, based on the nonvolatile fractions of the aqueous coating compositions.

Preference is given to functional complementary groups (b) in the crosslinking agent (V) that react with the preferred functional groups (a) selected from the group of hydroxyl, amino and/or epoxy groups. Particularly preferred complementary groups (b) are selected from the group of the carboxyl groups, of the optionally blocked polyisocyanate groups, of the carbamate groups and/or of the methylol groups, which where appropriate are partly or fully etherified with alcohols.

Very particular preference is given to functional complementary groups (b) in the crosslinking agent (V) that react with the particularly preferred hydroxyl groups as functional groups (a), with (b) being selected preferably from the group of the optionally block polyisocyanate groups and/or of the methylol groups, which where appropriate are partly or fully etherified with alcohols.

Examples of suitable polyisocyanates and of suitable blocking agents are described for example in EP-A-1 192 200, the blocking agents having the function in particular of preventing unwanted reaction of the isocyanate groups with the reactive groups (a) of the polymer (P) used for the process of the invention, and also with further reactive groups in further components of the coating composition used for the process of the invention, both before and during the application. The blocking agents are selected such that the blocked isocyanate groups deblock again only within the temperature range in which the thermal crosslinking of the coating composition is to take place, more particularly in the temperature range between 120 and 180 degrees C., and enter into crosslinking reactions with the functional groups (a).

As components containing methylol groups it is possible in particular to use water-dispersible amino resins, of the kind described for example in EP-A-1 192 200. Preference is given to using amino resins, especially melamine-formaldehyde resins, which react in the temperature range between 100 and 180 degrees C., preferably between 120 and 160 degrees C., with the functional groups (a), in particular with hydroxyl groups.

### Further Constituents of the Aqueous Coating Composition of the Invention

Besides the aforementioned binders and crosslinking agents (V), the coating composition of the invention may comprise further, optionally functionalized, preferably water-dispersible binder constituents in fractions of up to 40%, preferably up to 30%, by weight, based on the nonvolatile constituents of the coating composition.

The coating composition of the invention may further comprise customary coatings additives in effective amounts. Thus, for example, color and effect pigments, and also customary fillers, in known amounts, may be part of the coating composition. The pigments and/or fillers may consist of organic or inorganic compounds and are set out by way of example in EP-A-1 192 200. Further additives which can be used are, for example, UV absorbers, free-radical scavengers, slip additives, polymerization inihibitors, defoamers, emulsifiers, wetting agents, flow control agents, film-forming auxiliaries, rheology control additives, and, preferably, catalysts for the reaction of the functional groups (a), (b) and/or groups (c), and additional crosslinking agents for the functional groups (a), (b) and/or (c). Further examples of suitable coatings additives are described for example in the textbook “Lackadditive” [Additives for Coatings] by Johan Bieleman, Wiley-VCH, Weinheim, N.Y., 1998.

The aforementioned additives are present in the coating composition of the invention preferably in fractions of up to 40%, more preferably up to 30%, and with particular preference up to 20%, by weight, based on the nonvolatile constituents of the coating composition.

### The Preparation and Application of the Aqueous Coating Composition of the Invention, and the Characterization of the Resulting Coating Films

The coating composition of the invention can be prepared by all of the processes that are known and customary in the coatings field, in suitable mixing assemblies, such as stirred tanks, dissolvers or Ultraturrax.

Preferably the aqueous preparation (WZ) is introduced to start with and the film-forming water-dispersible polymer (FP), the crosslinking agent (V) and, where appropriate, the above-described further constituents are added with stirring. The aqueous effect basecoat material of the invention is preferably adjusted with water to a solids content of preferably 5% to 50%, more preferably of 10% to 45%, more particularly of 20% to 40%, by weight.

The resulting aqueous effect basecoat material of the invention, in particular the precursor composed of a mixture of the aqueous preparation (WZ) and the film-forming polymer (FP) before addition of the crosslinking agent (V), preferably likewise has liquid-crystalline properties.

The aqueous coating compositions of the invention are applied preferably in a wet film thickness such that, after curing, in the completed coats, a dry coat thickness results of between 1 and 100 μm, preferably between 5 and 75 μm, more preferably between 10 and 60 μm, in particular between 15 and 50 μm.

The application of the coating composition in the process of the invention may take place by customary application methods, such as spraying, knife coating, spreading, pouring, dipping or rolling, for example. Where spray application methods are employed, preference is given to compressed air spraying, airless spraying, high-speed rotational spraying, and electrostatic spray application (ESTA).

The application of the aqueous coating compositions of the invention is carried out in general at temperatures of not more than 70 to 80 degrees C., and so suitable application viscosities can be attained without the brief thermal exposure being accompanied by change or damage to the coating composition or to its overspray, which if appropriate may be reprocessed.

The preferred thermal treatment of the applied film of the coating composition of the invention takes place by the known methods, such as, for example, by heating in a forced air oven or by irradiation with infrared lamps. Advantageously the thermal cure takes place at temperatures between 80 and 180 degrees C., preferably between 100 and 160 degrees C., for a time of between 1 minute and 2 hours, preferably between 2 minutes and 1 hour, more preferably between 10 and 45 minutes. Where substrates are used, such as metals, for example, which have the capacity to withstand a high thermal load, the thermal treatment may also be carried out at temperatures above 180 degrees C. Generally speaking, however, it is advisable not to exceed temperatures of 160 to 180 degrees C. Where, on the other hand, substrates such as plastics, for example, are used which have a maximum limit to their ability to withstand thermal loads, the temperature and the time needed for the curing operation must be brought into line with this maximum limit. The thermal cure may take place after a certain rest time of 30 seconds to 2 hours, preferably of 1 minute to 1 hour, more particularly of 2 to 30 minutes. The rest time serves in particular for the flow and the degassing of the applied basecoat films or for the evaporation of volatile constituents, such as solvents or water. The rest time may be assisted and shortened through the application of elevated temperatures of up to 80 degrees C., provided this is not accompanied by any damage or change to the applied films, such as premature complete crosslinking, for instance.

The above coating composition is used in accordance with the invention for increasing the stonechip resistance in OEM coat systems on metallic substrates and/or plastics substrates, which, in the case of metal substrates, consist, as viewed from the substrate, of an electrolytically deposited corrosion protection coat, preferably a cathodically deposited coat, of a surfacer coat applied thereto, and of a topcoat applied to the surfacer coat, the topcoat being composed preferably of a color-imparting basecoat material and a concluding clearcoat material. The coating compositions prepared in accordance with the invention are used in this case to construct at least one of the coats in the OEM coat system. Preferably the coating compositions prepared in accordance with the invention are used to construct the surfacer coat.

When the coating material prepared in accordance with the invention is employed as a surfacer, it is preferred for the electrocoat material, more particularly the cathodic coating material, to be cured before the coating composition of the invention is applied. In a further preferred process, first of all a basecoat material and, to conclude, a clearcoat material are applied in two further stages to the film formed from the coating composition of the invention. In that case, in a preferred process, first the film of the coating composition of the invention is cured, and then, preferably, in a first step an aqueous basecoat material is applied, and, after an intermediate flash-off for a time of between 1 to 30 minutes, preferably between 2 and 20 minutes, at temperatures between 40 and 90 degrees C., preferably between 50 and 85 degrees C., it is overcoated in a second step with a clearcoat material, preferably a two-component clearcoat material, and basecoat and clearcoat are jointly cured.

In a further preferred embodiment of the invention, the surfacer coat produced with the coating composition of the invention is flashed off, prior to application of the basecoat film, for a time of between 1 to 30 minutes, preferably between 2 and 20 minutes, at temperatures between 40 and 90 degrees C., preferably between 50 and 85 degrees C. Thereafter, surfacer coat, basecoat film, and clearcoat film are jointly cured.

The OEM coat systems produced in this way exhibit excellent resistance to impact stress, more particularly to stone chipping. In comparison to OEM coat systems with prior-art surfacers, a reduction is observed in particular in the fraction of the surface that is damaged, and a very significant reduction is observed in the fraction of the surface that is completely worn away, in other words the fractional area of the unprotected substrate. In addition to these outstanding properties, the coatings produced with the coating compositions of the invention exhibit excellent condensation resistance, excellent adhesion to the corrosion protection coat and to the topcoat, more particularly to the basecoat, and excellent stability of the inherent color after curing, which also allows the coating compositions prepared in accordance with the invention to be used as a topcoat component. Moreover, with the coating composition of the invention, coatings can be realized that have a comparatively low baking temperature and a good topcoat appearance.

The examples which follow are intended to illustrate the invention.

### EXAMPLES

### Example 1

### Synthesis of an Aqueous Dispersion of an Inventive Polyester (PES)

A reactor with anchor stirrer, nitrogen inlet, reflux condenser, and distillation bridge is charged with 10.511 g of 1,6-hexanediol, 9.977 g of 2,2-dimethyl-1,3-propanediol, 6.329 g of cyclohexane-1,2-dicarboxylic anhydride, 23.410 g of dimeric fatty acid (Pripol®1012, Unichema, dimer content at least 97% by weight, trimer content not more than 1% by weight, monomer content not more than traces), and 0.806 g of cyclohexane. The contents of the reactor are heated at 220 degrees C. in a nitrogen atmosphere and with stirring until the reaction mixture has an acid number to DIN EN ISO 3682 of 8 to 12 mg KOH/g nonvolatile fraction and a viscosity of 3.7 to 4.2 dPas (measured as an 80% by weight solution of the reaction mixture in 2-butoxyethanol at 23 degrees C. in an ICI cone/plate viscometer). Thereafter the cyclohexane is distilled off and the reaction mixture is cooled to 160 degrees C.

After that, the reaction mixture is admixed with 10.511 g of 1,2,4-benzenetricarboxylic anhydride, heated to 160 degrees C., and maintained at that temperature until the resulting polyester has an acid number to DIN EN ISO 3682 of 38 mg KOH/g nonvolatile fraction, a hydroxyl number to DIN EN ISO 4629 of 81 mg KOH/g nonvolatile fraction, a weight-average molecular weight Mw of about 19 000 daltons (determined by means of gel permeation chromatography in accordance with DIN standards 55672-1 to -3 with polystyrene as standard), and a viscosity of 5.0 to 5.5 dPas (measured as a 50% by weight solution of the reaction mixture in 2-butoxyethanol at 23 degrees C. in an ICI cone/plate viscometer).

The reaction mixture is cooled to 130 degrees C. and 2.369 g of N,N-dimethylamino-2-ethanol are added. After further cooling to 95 degrees C., 17.041 g of deionized water and 19.046 g of 2-butoxyethanol are added. The resulting dispersion is adjusted by addition of further N,N-dimethylamino-2-ethanol and deionized water to a pH of 7.4 to 7.8 and to a nonvolatile fraction of 60% by weight.

### Example 2

### Synthesis of an Aqueous Dispersion of an Inventive Polyurethane (PUR)

A reactor with anchor stirrer, nitrogen inlet, reflux condenser, and distillation bridge is charged with 30 g of 1,6-hexanediol, 16 g of benzene-1,3-dicarboxylic acid, 54 g of oligomeric fatty acid (Pripol®1012, Uniqema, dimer content at least 97% by weight, trimer content not more than 1% by weight, monomer content not more than traces) and 0.9 g of xylene. The contents of the reactor are heated at 230 degrees C. in a nitrogen atmosphere and with stirring until the reaction mixture has an acid number to DIN EN ISO 3682 of less than 4 mg KOH/g nonvolatile fraction and a viscosity of 11 to 17 dPas (measured at 50 degrees C. in an ICI cone/plate viscometer). The resulting polyester solution has a nonvolatile fraction of 73% by weight.

A further reactor with anchor stirrer, nitrogen inlet, reflux condenser, and distillation bridge is charged with 21.007 g of the above-described polyester solution, 0.205 g of 2,2-dimethyl-1,3-propanediol, 1.252 g of 2,2-bis(hydroxymethyl)propionic acid, 5.745 g of 2-butanone and 5.745 g of 3-isocyanatomethyl-3,3,5-trimethylcyclohexylisocyanate. The contents of the reactor are heated at 82 degrees C. in a nitrogen atmosphere and with stirring until the reaction mixture, in the form of a 2:1 dilution in N-methylpyrrolidone, has an isocyanate content of 0.8 to 1.1% by weight and a viscosity of 5 to 7 dPas (measured at 23 degrees C. in an ICI cone/plate viscometer). Thereafter the reaction mixtures is admixed with 0.554 g of 1,1,1-tris(hydroxymethyl)propane, heated to 82 degrees C., and held at that temperature until the reaction mixture, in the form of a 1:1 dilution in N-methylpyrrolidone, has an isocyanate content of less than 0.3% by weight and a viscosity of 12 to 13 dPas (measured at 23 degrees C. in an ICI cone/plate viscometer).

The reaction mixture is diluted with 5.365 g of 2-butoxyethanol, and admixed with 0.639 g of N,N-dimethylamino-2-ethanol. The resulting mixture is introduced into 60 g of deionized water, the temperature being held at 80 degrees C. Thereafter the 2-butoxyethanol is removed by distillation down to a residual level of less than 0.25% by weight, based on the reaction mixture. The resulting dispersion is adjusted by addition of further N,N-dimethylamino-2-ethanol and deionized water to a pH of 7.2 to 7.4 and a nonvolatile fraction of 27% by weight.

### Example 3

### Synthesis and Modification of Hydrotalcite

A 0.21 molar aqueous solution of 4-aminobenzenesulfonic acid (4-absa) is admixed over 3 hours with an aqueous mixture of ZnCl₂.6H₂O (0.52 molar) and AlCl₃.6H₂O (0.26 molar) at room temperature under a nitrogen atmosphere and with continual stirring. The pH is held constant at 9 by addition of a 3 molar NaOH solution.

Following addition of the aqueous mixture of the metal salts, the resulting suspension is aged at room temperature for 3 hours. The resulting precipitate is isolated by centrifuging and washed 4 times with deionized water.

The resulting suspension of the white reaction product Zn₂Al(OH)₆(4-absa).2H₂O (LDH suspension) has a solids content of 27.1% by weight and a pH of 9.

### Example 4

### Formulation of the Precursor for the Inventive Coating Composition

To prepare the liquid-crystalline aqueous preparation (WZ), 13.5 g of the hydrotalcite suspension prepared in Preparation Example 3 are introduced with stirring at room temperature into a mixture of 15.0 g of the aqueous polyester dispersion (PES) from Preparation Example 1, which has been diluted with 9.0 g of deionized water, and the mixture is stirred for 12 hours. This produces a viscous white dispersion which has streaks of the kind frequently observed in liquid-crystalline preparations.

Under crossed polarizers it is possible to perceive a nematic, liquid-crystalline, birefringent phase alongside an isotropic, nonbirefringent phase. Ultra-small-angle X-ray scattering shows an intensity maximum of the kind typical of lamellar structures. The 1st-order intensity maximum for a scattering vector q˜0.085 [1/nm] (for radiation with a wavelength λ=1.38 nm, measured at the synchrotron radiation laboratory HASYLAB, DORIS, BW4, DESY, Hamburg), corresponds to an interlayer spacing of 75 nm.

Thereafter the liquid-crystalline aqueous preparation (WZ) is admixed with 85.0 g of the aqueous polyurethane dispersion (PUR) from Preparation Example 2 as a film-forming polymer (FP), with stirring. The result is a storage-stable, milky dispersion of low viscosity which, based in each case on the dispersion, contains 7.4% by weight of polyester (PES), 18.7% by weight of polyurethane (PUR), 6.4% by weight of 2-butoxyethanol, and 3.0% by weight of hydrotalcite.

Small-angle X-ray scattering shows intensity maxima of the kind typical of lamellar structures. The 1st-order intensity maximum with a scattering vector q˜0.30 [1/nm] (for CuKα radiation with a wavelength λ=0.154 nm) corresponds to an interlayer spacing of 21 nm. Under crossed polarizers, no birefringent phase can be seen. After a heating phase (5 minutes at 100 degrees C.) of the covered film of liquid, the phase which is still always homogeneous has an increased intensity under identical settings of the crossed polarization filters and also of the exposure parameters.

### Example 5

### Preparation of the Inventive Coating Composition, its Application, and its Properties

To prepare the inventive coating composition, the precursor for the inventive coating composition, from Example 4, is aged overnight. Thereafter, as a crosslinking agent (V), 4.05 g of melamine-formaldehyde resin (MAPRENAL MF 900 from Ineos Melamines GmbH) are introduced with stirring into 100 g of the precursor from Example 4. The fraction of crosslinker (V), based on the nonvolatile fractions of the inventive aqueous coating composition, is 12% by weight.

The inventive aqueous coating composition prepared in this way is applied to pretreated steel panels that have also been precoated with a cathodic electrocoat material (steel panels from Chemetall: thickness of the baked cathodic electrocoat: 21+/−2 μm, thickness of the substrate: 750 μm) by means of spraying (Automatic Coater from Köhne). The resulting film of the inventive aqueous coating composition is cured at 140 degrees C. for 20 minutes, resulting in a dry film thickness of 30 +/−3 μm.

For comparison purposes, a commercial surfacer (FU43-9000 from BASF Coatings AG: reference surfacer) is applied to the pretreated steel panels that have also been precoated with a cathodic electrocoat in such a way, and cured at 150 degrees C. for 20 minutes in accordance with the manufacturer's instructions, so as to result likewise in a dry film thickness of 30 +/−3 μm.

The panels precoated in this way are additionally treated, for the purpose of producing an OEM coat system, by application in separate steps first of a commercial aqueous basecoat material (FV95-9108 from BASF Coatings AG), followed by flashing off at 80 degrees C. for 10 minutes, and, to conclude, of a solventborne 2-component clearcoat material (FF95-0118 from BASF Coatings AG). The aqueous basecoat film and the clearcoat film are cured jointly at 140 degrees C. for 20 minutes, after which the basecoat has a dry film thickness of about 15 μm and the clearcoat has a dry film thickness of about 45 μm.

The panels coated in this way are stored for 3 days at 23 degrees C. and 50% relative humidity.

The coated steel panels produced as described above are subjected to a DIN 55996-1 stonechip test, using 500 g each time of chilled iron granules (4 to 5 mm particle diameter, from Würth, Bad Friedrichshall) and setting an air pressure of 2 bar on the bombardment apparatus (model 508 VDA from Erichsen).

After the test panels damaged in this way have been cleaned, they are immersed into a solution of an acidic copper salt, and elemental copper is deposited on those areas of the steel substrate at which the bombardment has removed the coating completely.

The damage pattern over 10 cm² of each of the damaged and aftertreated test panels is captured using image processing software (SIS-Analyse, BASF Coatings AG, Münster). Evaluations are made of the fractions of the surfaces damaged by bombardment, and also of the fractions of the surfaces completely worn away, based in each case on the total surface area. Relative to the coat systems produced with the reference surfacer, the coat systems produced with inventive coating composition as a surfacer material exhibit a reduction in the fraction of damaged surface area and a very marked reduction in the fraction of surface area completely worn away, i.e., the proportional area of the unprotected metal substrate.

The adhesion to the coat of the cathodic electrocoat material and to the basecoat is excellent, and is reflected in a significantly reduced delamination at the layer boundaries. The coating produced with the coating composition of the invention, moreover, has excellent condensation resistance and a virtually unchanged inherent color after baking.

1. An aqueous coating composition comprising
at least one liquid-crystalline aqueous preparation (WZ) in fractions of 1% to 95% by weight, based on the aqueous coating composition,
at least one film-forming polymer (FP), and
at least one crosslinking agent (V).

2. The aqueous coating composition of claim 1, wherein the liquid-crystalline aqueous preparation (WZ) which comprises 10% to 99.9% by weight, based on the nonvolatile fractions of the aqueous preparation (WZ), of at least one water-dispersible polyester (PES) which comprises at least one crosslinkable reactive functional group (a) and is prepared using, in fractions of 7 to 50 mol %, based on the entirety of polyester constituent units, difunctional monomer units (DME) having aliphatic spacer groups (SP) of 12 to 70 carbon atoms between the functional groups (Gr), and
0.1% to 30% by weight, based on the nonvolatile fractions of the aqueous preparation (WZ), of positively charged inorganic particles (AT) in layer form, whose individual layers that are not further intercalatable have a ratio D/d of an average layer diameter (D) to an average layer thickness (d)>50 and whose charge is at least partly compensated by singly charged organic anions (OA).

3. The aqueous coating composition of claim 2, wherein the water-dispersible polyester (PES) comprises, in addition to the monomer units (DME), as further constituent units:
(ME1): 1 to 40 mol %, based on the entirety of the constituent units of the water-dispersible polyester (PES), unbranched aliphatic and/or cycloaliphatic diols having 2 to 12 carbon atoms,
(ME2): 1 to 50 mol %, based on the entirety of the constituent units of the water-dispersible polyester (PES), of branched aliphatic and/or cycloaliphatic diols having 4 to 12 carbon atoms,
(ME3): optionally 0 to 30 mol %, based on the entirety of the constituent units of the water-dispersible polyester (PES), of branched aliphatic, cycloaliphatic and/or aromatic dicarboxylic acids having 4 to 12 carbon atoms,
and
(ME4): optionally 0 to 40 mol %, based on the entirety of the constituent units of the water-dispersible polyester (PES), of aliphatic, cycloaliphatic and/or aromatic polycarboxylic acids having at least 3 carboxylic acid groups.

4. The aqueous coating composition of claim 2, wherein the film-forming polymer (FP) comprises at least one water-dispersible polyurethane (PUR) incorporating polyester constituent units (PESB) which as constituent units comprise difunctional monomer units (DME).

5. The aqueous coating composition of claim 1, wherein the crosslinking agent (V) comprises at least two crosslinkable functional groups (b) which react with the functional groups (a) of the polyester (PES) and/or of the film-forming polymer (FP), when the coating composition is cured, to form covalent bonds.

6. The aqueous coating composition of claim 2, wherein the inorganic particles (AT) comprise at least one mixed hydroxide of the general formula
(M₍₁₋ₓ₎²⁺Mₓ³⁺(OH)₂)(A_{x/y}^{y-}).nH₂O
where M²⁺ represents divalent cations, M³⁺ represents trivalent cations, and (A) represents anions having a valence y, and where at least some of the anions (A) are replaced by singly charged organic anions (OA).

7. The aqueous coating composition of claim 6, wherein the organic anions (OA) comprise carboxylic acid groups, sulfonic acid groups and/or phosphonic acid groups as anionic groups (AG).

8. The aqueous coating composition of claim 6, wherein the organic anions (OA) comprise, in addition to the anionic groups (AG), additional functional groups (c) selected from the group of hydroxyl, epoxy and/or amino groups.

9. A method of coating a substrate, comprising applying to a substrate the aqueous coating composition of claim 1 in an OEM coat system.

10. An OEM coat system consisting of primer coat, surfacer coat, basecoat, and clearcoat, wherein at least one of the coats comprises the aqueous coating composition as claimed in claim 1.
